(19) United States
(12) Patent Application Publication
(10) Pub. No.: US 2003/0146808 A1
(43) Pub. Date: Aug. 7, 2003

(54) Apparatus and method of manufacture for time delay signals

(76) Inventor: Jeffrey C. Merrill, Manlius, NY (US)

Correspondence Address: MICHAEL P. WILLIAMS, BOND, SCHOENECK & KING, PLLC, ONE LINCOLN CENTER, SYRACUSE, NY, 13202, US

(21) Appl. No.: 10/062,249

(22) Filed: Feb. 1, 2002

(51) Int. Cl. H01P 1/18

(52) U.S. Cl. 333/161; 333/156

(57) ABSTRACT

A circuit element that increases time delay in the propagation of an electromagnetic signal includes a plurality of conductors and bends, the conductors mounted with a gap and in parallel to one another, for generating a time delayed signal. The conductors have a first line width, length, and thickness for generating an impedance. The second end of a conductor is connected to the first end of a following conductor by a bend wherein the bend has a second line width, radius and thickness for electrically connecting said conductors in a series circuit. The conductors and bends are surface etched.

### FIELD OF THE INVENTION

The present invention relates to a circuit element, and more particularly to a time delay circuit, which is used, for example, to time delay the propagation of an electromagnetic signal.

### BACKGROUND OF THE INVENTION

In the field of communications electronics, there is a need to employ time delays to the propagation of selected electromagnetic signals. There are known in the art a number of methods of accomplishing time delay of selected electromagnetic signals, including the use of coaxial cables, filters and phase shifters.

It is common in the microwave communication industry to impart time delay from input to output by increasing path length using standard coaxial cable cut to a specific length to yield a desired time delay. Coaxial transmission line provides a good phase linearity. For example, to provide a 25 ns delay a coaxial cable length of about 20 feet is needed. Such a cable is very expensive and bulky, even when coiled upon itself. Of course, longer delays require longer cable and higher cost. This is a major disadvantage towards the miniaturization of microwave circuitry. The time delay is a linear delay because the delay value is the same for all frequencies within the operating range of the cable. This manufacturing technique is expensive and labor intensive. Furthermore, large volumes of space are required when coiled coaxial cable is used to generate a time delayed signal in the microwave circuit.

The demands of cutting-edge digital communication systems such as wireless communications networks consisting of power amplification linearization networks with pre-distortion and feedforward circuitry are being met with microwave technology. The growth in popularity of these systems has driven the need for compact, lightweight, and surface-mountable packaging of microwave integrated circuits. In the arena of time delaying the propagation of an electromagnetic signal, what is needed is an apparatus that provides the aforementioned time delay in a compact packaging design. This includes a design that uses less surface area, uses less complex circuitry, and reduces cost over that which is currently available in the prior art.

### SUMMARY OF THE INVENTION

It is an aspect of the invention to provide microwave circuitry for time delaying signals using less surface mounted area.

It is another aspect of the invention to provide less complex microwave circuitry for time delaying signals.

It is still another aspect of the invention to provide microwave circuitry for time delaying signals at a lower cost over the prior art.

To accomplish these aspects a circuit element that increases time delay in the propagation of an electromagnetic signal includes a plurality of conductors and bends, the conductors printed with a gap and in parallel to one another, for generating a time delay signal. The conductors have a first line width, length, and thickness for generating an impedance. The second end of a conductor is connected to the first end of a following conductor by a bend wherein the bend has a second line width, radius and thickness which electrically connects said conductors in a series circuit. The conductors and bends are etched.

These and other aspects of the invention will become apparent from the following description, the description being used to illustrate a preferred embodiment of the invention when read in conjunction with the accompanying drawings.

### BRIEF DESCRIPTION OF THE DRAWINGS

FIG. 1 is a plan view of the time delay element as a pair of conductors and a bend.

FIG. 1A is a plan view of the time delay element as a pair of conductors and a bend on a circuit board.

FIG. 2 is a plan view of a preferred embodiment of the invention showing a time delay circuit comprising a plurality of conductors and bends.

FIG. 2A is a cross view of a preferred embodiment of the invention showing a time delay circuit comprising a plurality of conductors and bends positioned in layers.

### DETAIL DESCRIPTION OF THE INVENTION

While the present invention is described below with reference to microwave circuits, a practitioner in the art will recognize the principal of the present invention is applicable in other electronic circuit applications.

Microwave circuits using linear transmission line can be formed using flat-layered structures such as stripline. A stripline circuit is a pattern of flat conductors sandwiched between a pair of flat, sheet-like, ground plane conductors and spaced from the ground plane conductors by a pair of intervening sheets of dielectric material. However, heretofore traditional stripline structures have not been suitably arranged for high frequency precision delays lines.

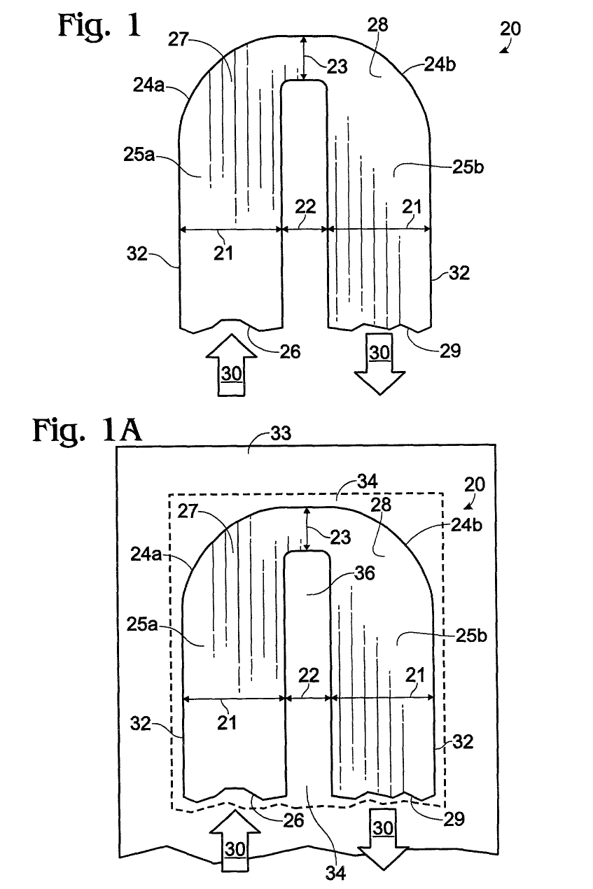

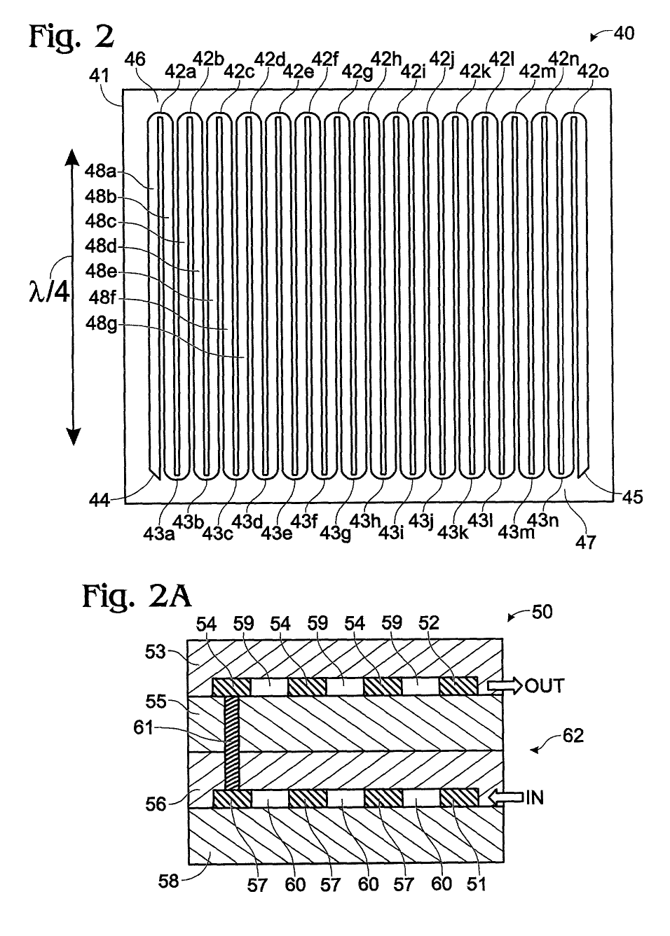

Now referring to FIG. 1, a time delay element 20 is shown in the preferred embodiment of the invention. A first conductor 25a is connected electrically in series to a second conductor 25b. As understood by the practitioner in the art, many conductors are connected in series depending on the design criteria of the amount of time delay required for a particular circuit. The first conductor 25a has as first linewidth 21 and length 32. The first linewidth 21 distance, in combination with the length 32 and conductor thickness, determines the impedance of the first conductor 25a. It follows that the second conductor 25b also has a first linewidth 21, thickness and length 32, that is identical to the first conductor 25a. However, depending on design characteristics of the circuit, the length, thickness and linewidth of each conductor is variable. The first linewidth 21 distance, in combination with the length 32 and thickness, determines the impedance of the second conductor 25b. The first conductor 25a is surface etched or printed (lithographed) in parallel to the second conductor 25b, and the first and second conductors are separated by a gap 22 that is small placing the first conductor 25a in close proximity to the second conductor 25b. The first bend 24a is connected to the second end 27 of the first conductor 25a and to the second bend 24b. The second bend 24b is then connected to the first end 28 of the second conductor. When the first conductor 25a and second conductor 25b are surface etched or printed (lithographed) in this manner, an image impedance occurs between them. These conductors have a total length equating to 180 phase degrees at the frequency where the circuit is tuned, that is, two 90 degree long coupled conductors connected at one end. Consequently, this circuit will have a longer electrical length than that calculated by the conductor linear length alone, due to the coupling affect between the conductors. As shown in FIG. 2, many conductors and bends are etched or printed (lithographed) in series on a circuit board, each of which equates to 180 phase degrees.

The flow of current 30 enters at the first end 26 of the first conductor 25a and exits at the second end 27 of the first conductor 25a. The current 30 flows, through the first bend 24a and the second bend 24b, into the first end 28 of the second conductor 25b, through the second conductor 25b, and exits the second conductor 25b at the second end 29. The first bend 24a and the second bend 24b are optimally curved along with a second linewidth 23 distance that is optimally sized, to minimize reflections through the first bend 24a and second bend 24b. This means the radius of the first bend 24a and the radius of the second bend 24b, the thickness of the first and second bend, and the second linewidth 23, are selected to minimize reflections. The radius, thickness and second line width will achieve a particular impedance value in the first and second bends. The conductors and bends are typically a flat strip of material. However, the flat strip is substitutable with other forms of strip material including, but not limited to, foil, spherical, oval, rectangular, circular, and the like. The first bend 24a and second bend 24b are connected similarly to following conductors when the circuit has a plurality conductors.

The first conductor 25a and second conductor 25b are electrically connected in series. When current 30 flows through the first conductor 25a and the second conductor 25b, an image impedance is formed because the first conductor 25a is in close proximity to the second conductor 25b. Consequently the time delay element 20 creates a desirable differential-phase response that equates to the specific time delay of the propagation of the electromagnetic signal.

In one embodiment, a time delay element 20 is formed by patterned microstrip lines, that include a first conductor 25a, a first bend 24a, a second bend 24b and a second conductor 25b, of a thin sheet of conductive material. The thin sheet is positioned upon on a dielectric (not shown). The ground plane is then deposited on a dielectric (not shown). However, one skilled in the art would recognize that conductive material can be deposited upon a dielectric that has been previously laminated to a ground plane surface.

In the another embodiment of the invention, a time delay element 20 is formed by patterned microstrip lines, that include a first conductor 25a, a first bend 24a, a second bend 24b and a second conductor 25b, of a thin sheet of conductive material. This is accomplished by the lithograph process or etching a stripline from conductive material on a dielectric. The time delay element is imbedded into, for example, a surface mountable package that is formed by dielectric layers wherein one dielectric layer has two sides clad with coupling conductors formed on the cladding material using conventional photo-lithographic techniques.

The time delay element 20, in another embodiment of the invention as shown in FIG. 1A, is mounted directly on an circuit board 33 that has a cavity 34. Filling the cavity 34 with a dielectric material 36 of a higher dielectric constant than air, for example, materials including, but not limited to, PTFE-based microwave materials as is known in the art. These materials are typically ceramically-loaded. This provides greater delay per length of transmission line. The dielectric material 36 is either injected or positioned into the cavity 34, of the time delay element 20, after the elements have been assembled.

Now referring to FIG. 2, a time delay circuit 40 is shown mounted on a circuit board 41. A first side 46, of the time delay circuit 40, includes bends 42a, 42b, 42c, 42d, 42e, 42f, 42g, 42h, 42i, 42j, 42k, 42l, 42m, 42n and 42o. A second side 47, of the circuit 40, includes bends 43a, 43b, 43c, 43d, 43e, 43f, 43g, 43h, 43l, 43j, 43k, 43i, 43m and 43n. A signal enters circuit 40 at a first location 44 and exits the circuit at a second location 45. The circuit 40 is a ¼λ electrical length transmission line or a multiple thereof. A number of conductors, for example conductors 48a, 48b, 48c, 48d, 48e, 48f, 48g and the like, can be placed parallel to one another in a series circuit, wherein the time delay of a signal per unit area can be increased. This effect combined with the fact that the lines are closer together, as compared to the case when phase linearity is desired, maximizes the possible electrical delay per unit area. As is understood by the practitioner of the art, the circuit 40 is workable with a plurality of time delay elements 20. Various time delay element 20 patterns are etched or printed on a circuit board or surface for arranging a long transmission path within a desired area of a circuit board or surface. For example, a different pattern is one that meanders on board 41, or is arranged in layers as shown in FIG. 2A. However, as shown in FIG. 2, many conductors are printed on a circuit board 41 in a single conductive layer. As a practitioner of the art readily understands, any pattern is possible so long as the parameters of the time delay element 20 are maintained. The parameters include conductors electrically connected in series, positioned in close proximity to each other, in parallel to one another, and ¼λ electrical length or multiple thereof.

The conductors and bends of the time delay circuit 40 are metal layers formed by metalizing the substrate (circuit board) 41 with copper that is typically 0.0002 to 0.0100 inches thick and is preferably about 0.001 inches thick. As a practitioner of the art understands, copper is substitutable for aluminum, gold, silver or any conductive material with the thickness of the metal layers depending on the design. In the preferred embodiment, the substrate 41 typically has layers that are bonded together, for example, like the method of using thermoset or thermoplastic bonding films. However, alternate methods of bonding may be used, for example, like the method of using a fusion process having specific temperature and pressure profiles to form a multilayer structure.

As shown in FIG. 2A, a stack of conductor layers consist of a first conductor layer 54 and second conductor layer 57. There also exists a first dielectric layer 53, a second dielectric layer 55, a third dielectric layer 56, and a fourth dielectric layer 58. The conductors and dielectric layers are formed into a laminated circuit assembly or module 62. The circuit 50, a single or multilayer structure, typically has one or many conductor layers depending on the time delay desired. The conductor layers are typically 0.002 inches to 0.100 inches thick and are a conductive material such as copper, aluminum, and the like. The material used to form the assembly 62 is a composite of plastic, PTFE, glass, or ceramic depending on the application. The dielectric layers are typically 0.01 inches to 0.200 inches thick and are ferroelectric materials. As can be seen gap 59 separates the first layer of conductors 54 that are connected in series. Also, a gap 60 separates the second layer or conductors 57 that are connected in series. The gap is filled with air or contains a dielectric material with a dielectric constant greater than air to decrease electromagnetic signal speed in circuit 50. As one skilled in the art would recognize, upon formation of the assembly typically the gap is filled with dielectric material as a result of compression or fusion of the surrounding materials. In circuit 50, the higher the dielectric constant of the dielectric material, the slower the electromagnetic signal propagates. The first conductor layer 54 is connected to the second conductive layer by way of a metalized through-hole 61 routed through the second dielectric 55 and third dielectric 56.

An electromagnetic signal enters the time delay circuit 50 at a first location 51, then travels through a second conductor 57, a first metalized through-hole 61, and a first conductor 54, leaving the time delay circuit 50 at a second location 52. A first conductor 54 is sandwiched between and a first dielectric 53 and a second dielectric 55 consisting of a ferroelectric material. A second conductor 57 is sandwiched between a third dielectric 56 and a fourth dielectric 58 consisting of a ferroelectric material. The third dielectric 55 is laminated to the second dielectric 55, wherein a conductive metalized through-hole 61 connects the first conductive layer 53 to the second conductive layer 57. All the conductors, dielectrics, and through-hole are encapsulated into a module 62.

The first conductor layer 54 is separated by a first gap 59. The first gap 59, which is the distance between the respective conductor striplines, in the first layer 54 is determined depending on the optimum placement of the striplines for generating the required image impedance. The striplines of the first conductive layer 54 are positioned in parallel to one another. The striplines are connected in series forming the coupling that time delays the electromagnetic signal. The second conductor layer 57 is separated by a second gap 60. The second gap 60, which is the distance between the respective conductor striplines, in the second layer 57 is determined depending on the optimum placement of the striplines for generating the required image impedance. The striplines of the second conductive layer 57 are positioned in parallel to one another. The striplines are connected in series forming the coupling that time delays the electromagnetic signal. The first gap 59 and second gap 61 distance is determined depending on the design criteria of circuit 50 but are in close proximity to create the time delay circuit. These conductors will have a total length equating to 180 phase degrees at the frequency where circuit 50 is calculated, that is, two 90 degree long coupled strips connected at one end. However, the conductors in circuit 50, because of the coupling, will have a longer electrical length than calculated by the linear distance alone. Consequently, the circuit 50 has a longer delay time for the propagation of the electromagnetic signal.

The dielectric material of the first dielectric 53, the second dielectric 55, third dielectric 56 and fourth dielectric 58 typically has a higher dielectric constant than air and includes, but is not limited to, PTFE materials. These dielectric materials reduce the electromagnetic signal speed further than air when used in the gap between the conductors in the time delay circuit. A practitioner in the art readily understands many ferroelectric dielectrics are substitutable as along as their dielectric constant is greater than air.

In the embodiment of the invention, as shown in FIG. 2A, the metal layers that include, the first conductor 54 and the second conductor 57 are formed by metalizing substrate layers with copper or other materials like aluminum, gold or silver. Alternately, the metal layers are formed through etching, printing or lithography as is known in the art. The metal layers are typically 0.0002 to 0.0100 inches thick, but preferably about 0.001 inches thick.

The metal layers are connected by a through-hole 61. The through-hole is typically plated with copper, but the copper is substitutable with aluminum, silver, gold or other suitable conductive material. The through-hole is circular and about 0.0050 to 0.10 inches in diameter. The actual through-hole diameter size is determined in conjunction with its the metal layer thickness and length to provide a specific impedance in the circuit 40. The through-hole is positioned where the signal exists the second conductive layer 57 and enters the first conductive layer 54. Thus, the entrance end of one conductive layer connects to the exit end of the previous conductor. As is understood by the practitioner in the art, the first layer 54 and second layer 57 is substitutable for may conductive layers with many conductive through-holes connecting preceding and successive conductive layers. Also, the circular through-hole is substitutable for a variety of shapes including, but not limited to oval, square and rectangle.

The first dielectric 53, the second dielectric 55, the third dielectric 56 and fourth dielectric 58 layers are bonded together using a fusion process having specific temperature and pressure profiles to form the multilayer circuit 50. They typically contain homogeneous dielectric materials. However, alternate methods of bonding may be used, for example, methods using thermoset or thermoplastic bonding films. The fusion bonding process is understood by those of ordinary skill in the art of manufacturing multilayered polytetra-fluoroethylene (PTFE) circuitry.

Now referring back to FIG. 2 the operation of the time delay circuit 40 allows the effect of maximizing an electromagnetic signal delay time per unit of area. The electromagnetic signal is transmitted into circuit 40 at a first location 44 and travels through the multiple time delay element conductors that are connected in series on board 41. The electromagnetic signal leaves the circuit, after a delayed time, at a second location 45. The multitude of time delay element conductors will have a total physical length equating to a multiple of 180 phase degrees at the frequency the circuit is designed because there are two 90 degree long coupled strips, or multiples thereof, connected at one end. For instance, the total length of the coupled strips could equate to 180 phase degrees, or 270 phase degrees, or 360 phase degrees. However, this circuit will have a longer electrical length than calculated by the physical conductor length because of the time delay circuit. This time delay circuit creates an image impedance as a result of the closely spaced conductors and provides a transmission line that increases an electromagnetic signal delay per unit of area over the equivalent length of transmission line conductor that is not closely spaced.

While there has been illustrated and described what is at present considered to be a preferred embodiment of the invention, it will be appreciated that numerous changes and modifications are likely to occur to those skilled in the art. It is intended in the appended claims to cover all those changes and modifications that fall within the spirit and scope of the present invention.

What is claimed is:

1. A circuit that increases time delay in the propagation of an electromagnetic signal, comprising:
a plurality of conductors and bends, said conductors having a first linewidth, thickness, and length for generating an image impedance, said bends having a second linewidth, radius and thickness for electrically connecting said conductors in a series circuit; and
an end of one of said conductors is connected to an end of a following said conductor by a bend, wherein said conductors and bends are printed to form a gap between adjacent conductors and whereby an electromagnetic signal passing through said circuit comprises a time delayed signal.

2. The circuit as claimed in claim 1, wherein said conductors are a plurality of shapes.

3. The circuit as claimed in claim 1, wherein said bends are a plurality of shapes.

4. The circuit as claimed in claim 1, wherein said conductors further comprise a first linewidth, a length and a thickness for a selected impedance characteristic.

5. The circuit as claimed in claim 1, wherein said bends further comprise a second linewidth, a radius and a thickness for a selected impedance characteristic.

6. The circuit as claimed in claim 1, wherein said conductors and bends are positioned in a cavity.

7. The circuit as claimed in claim 6, wherein said cavity is filed with a plurality of dielectric materials with a dielectric constant greater than air.

8. The circuit as claimed in claim 1, wherein said conductors are stacked with dielectric layers sandwiched between said conductors forming a multilayer structure.

9. The circuit as claimed in claim 1, wherein said bends are positioned along side dielectric layers and said conductors forming a multilayer structure.

10. The circuit as claimed in claim 8, wherein said multilayer structure is bonded using thermoplastic films.

11. The circuit as claimed in claim 8, wherein said multilayer structure is bonded using thermoset films.

12. The circuit as claimed in claim 8, wherein said multilayer structure is fused together.

13. The circuit as claimed in claim 9, wherein said bends are formed as through-holes.

14. The circuit as claimed in claim 13, wherein said through-holes are plated with a plurality of conductive materials.

15. The circuit as claimed in claim 8, wherein said multi-layer structure is a laminated circuit assembly.

16. The circuit as claimed in claim 1, wherein said conductors and bends each further consists of two 90 phase degree strips connected at one end equating to a 180 phase degree at a calculated frequency.

17. The circuit as claimed in claim 1, wherein said conductors and bends are positioned to form a plurality of patterns on a surface.

18. The circuit as claimed in claim 1, wherein said etching is substitutable for printing.

19. The circuit as claimed in claim 1, wherein said etching is substitutable for lithography.

20. A method of manufacturing a circuit that increases time delay in the propagation of an electromagnetic signal, comprising:
positioning a plurality of conductors and bends, said conductors having a first linewidth, thickness and length for generating an image impedance and said bends having a second linewidth, radius and thickness for electrically connecting said conductors in a series circuit, wherein an end of one of said conductors is connected to an end of a following said conductor by a bend and wherein said conductors and bends are etched to form a gap between adjacent conductors and whereby an electromagnetic signal passing through said circuit comprises a time delayed signal.

21. The method of manufacturing a circuit as claimed in claim 20, wherein said conductors comprise a plurality of shapes.

22. The method of manufacturing a circuit as claimed in claim 20, wherein said bends comprise a plurality of shapes.

23. The method of manufacturing a circuit as claimed in claim 20 wherein said conductors further comprises a first linewidth, a length and a thickness for a selected impedance characteristic.

24. The method of manufacturing a circuit as claimed in claim 20, wherein said bends further comprises a second linewidth, a radius and a thickness for a selected impedance characteristic.

25. The method of manufacturing a circuit as claimed in claim 20, wherein said conductors are positioned in a cavity on a surface mountable module.

26. The method of manufacturing a circuit as claimed in claim 25, wherein said cavity is filed with a plurality of dielectric materials with a dielectric constant greater than air.

27. The method of manufacturing a circuit as claimed in claim 20, wherein said conductors are stacked with dielectric layers sandwiched between said conductors forming a multi-layer structure.

28. The method of manufacturing a circuit as claimed in claim 20, wherein said bends are positioned along side dielectric layers and said conductors forming a multilayer structure.

29. The method of manufacturing a circuit as claimed in claim 27, wherein said multilayer structure is bonded using thermoplastic films.

30. The method of manufacturing a circuit as claimed in claim 27, wherein said multilayer structure is bonded using thermoset films.

31 The method of manufacturing a circuit as claimed in claim 27, wherein said multilayer structure is fused together.

32. The method of manufacturing a circuit as claimed in claim 28, wherein said bends are formed as through-holes.

33. The method of manufacturing a circuit as claimed in claim 32, wherein said through-holes are plated with a plurality of conductive materials.

34. The method of manufacturing a circuit as claimed in claim 20, wherein said conductors and bends each further consists of two 90 phase degree strips connected at one end equating to a 180 phase degree at a calculated frequency.

35. The method of manufacturing a circuit as claimed in claim 20, wherein said conductors and bends consists of a plurality of patterns on a surface.

36. The method of manufacturing a circuit as claimed in claim 20, wherein said etching is substitutable for printing.

37. The method of manufacturing a circuit as claimed in claim 20, wherein said etching is substitutable for lithography.
